(19) United States
(12) Patent Application Publication
(10) Pub. No.: US 2021/0407006 A1
(43) Pub. Date: Dec. 30, 2021

(54) DATA PACKAGING AND SEPARATION TECHNIQUE AND DATA PACKAGE FOR ASSET SWAP FUTURE

(71) Applicant: DEUTSCHE BORSE AG, Eschborn (DE)

(72) Inventors: Maesa Beany, London (GB); Stuart Heath, Brasted (GB)

(21) Appl. No.: 17/471,468

(22) Filed: Sep. 10, 2021

Related U.S. Application Data
(63) Continuation-in-part of application No. 16/182,661, filed on Nov. 7, 2018.
(60) Provisional application No. 62/582,342, filed on Nov. 7, 2017.

(51) Int. Cl. G06Q 40/04; G06Q 30/02

(52) U.S. Cl. CPC G06Q 40/04; G06Q 30/0206

(57) ABSTRACT

A data processing system and a corresponding method, user interface and data package are provided where a packaging component builds a data package by combining s bond future data and matching swap data, and stores the built data package in a storage. A calculation component calculates a value for the data package and repeats the calculation to calculate updated values until a predetermined time period has expired. A separation component generates, after the predetermined time period has expired, first data and second data and output this data. The first data indicates a bond associated with the bond future data, and the second data indicates a swap associated with the swap data.

### RELATED APPLICATION DATA

This application is a continuation-in-part of U.S. application Ser. No. 16/182,661 filed on Nov. 7, 2018, the entire disclosure of which is incorporated herein by reference.

### BACKGROUND

Computer systems, methods of operating computer systems, and computer-readable storage media are provided, and in particular systems, methods and media that may be used for packaging and processing data in a financial market.

Government bond asset swaps are usually traded as a combination of the cash bond with an over-the-counter (OTC) swap, or as a combination of a bond future and an OTC swap. A yield yield asset swap package is the combination of a bond and a duration weighted “at market” swap (a swap traded at the current market rate), with matching dates to the bond. The asset swap spread is the difference between the yield of the bond and the yield (at market swap rate) of the swap. Data processing in this field requires a significant amount of computational and processing resources to deal with a tremendous data amount under extraordinarily difficult time constraints. This is particularly the case when processing financial products such as asset swaps where data packages for such products are continuously generated, valuated and updated, and then respective updated packages are generated and the process is repeated again and again. There is a need to provide a data packaging and separation technique, and a corresponding data package, that allow for trading and/or clearing financial products such as those mentioned above in a technically most efficient manner.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

As will be apparent from the following, embodiments provide for performing repeated calculations on a data package before it undergoes separation. Thus, it is not necessary anymore to repeatedly build and store updated data packages.

In an embodiment, there is provided a computer system that has a storage and a data processing system. The data processing system comprises a packaging component, which is configured to build a data package by combining bond future data and matching swap data, and store the built data package in the storage. The data processing system further comprises a calculation component, which is configured to calculate a value for the data package and repeat the calculation to calculate updated values until a predetermined time period has expired. Moreover, the data processing system comprises a separation component, which is configured to, after said predetermined time period has expired, generate and output first data and second data. The first data indicates a bond associated with the bond future data, and the second data indicates a swap associated with the swap data.

The calculation component may be configured to calculate a value for the data package by performing acts comprising determining a bond future price in 20 accordance with the bond future data, and converting the bond future price into a forward yield.

The act of converting the bond future price into a forward yield may comprise calculating a bond forward price as

$$\frac{FV}{{( 1 + y )}^{n}} + {\sum }_{i = 1}^{n} [ {CF}_{i} . \frac{1}{{( 1 + y )}^{i}} ]$$

wherein y is the yield to maturity of the bond, i is the time until the i^{th} payment will be received, n is the time to maturity of the bond, FV is the bond face value, and CFᵢ is the coupon of the i^{th} payment from the bond.

In an embodiment, the calculation component may be configured to calculate a value for the data package by performing acts comprising calculating a bond duration as

$$\frac{{\sum }_{i = 1}^{n} \frac{CFi . {( 1 + y )}^{- i}}{V}}{( 1 + y )} \cdot \frac{1}{100} ( \frac{FV}{{( 1 + y )}^{n}} + {\sum }_{i = 1}^{n} [ {CF}_{i} . \frac{1}{{( 1 + y )}^{i}} ] ) ,$$

wherein y is the yield to maturity of the bond, i is the time until the i^{th} payment will be received, n is the time to maturity of the bond, FV is the bond face value, V is the present value of all cash payments from the bond until maturity, and CFᵢ is the coupon of the i^{th} payment from the bond.

Further, the calculation component may be configured to calculate a value for the data package by performing acts comprising determining a transacted spread (asset swap spread) of the data package, and adding the forward yield to the transacted spread to calculate a par swap rate. The calculation component may be configured to calculate a value for the data package by performing acts comprising calculating a swap duration.

In an embodiment, the data processing system may be configured to track a yield yield spread and repeatedly re-align the swap to match the bond details. The bond's forward yield to maturity, bond duration, swap duration and transacted spread may be required to determine the details of the re-aligned or matching swap.

A matching swap may imply a swap with the following specifications:
Start date of the swap would match the delivery day of the bond future and the expiry date of the swap would match the maturity date of the bond.
The notional of the swap may also be adjusted to ensure that the data package is duration neutral.

Moreover, there is provided a computer-implemented method of operating a computer system, where the method comprises building a data package by a packaging component of the computer system. The packaging component combines bond future data and matching swap data to build the data package therefrom. The method further comprises storing the built data package in a storage of the computer system. Further, the method comprises calculating a value for the data package by a calculation component of the computer system and storing the calculated value in a memory of the computer system, and repeatedly calculating and storing updated values until a predetermined time period has expired. Moreover, the method comprises, after said predetermined time period has expired, generating and outputting first data and second data by a separation component of the computer system. The first data indicates a bond associated with the bond future data, and the second data indicates a swap associated with the swap data.

Another embodiment is a computer-implemented method of operating a computer system, and a corresponding computer system, the computer system including at least one processing unit, a display device, and at least one memory having computer-executable instructions stored therein which, when executed by the at least one processing unit, cause the computing system to accomplish the method comprising: receiving a set of bond future data through an input element displayed on the display device; in response to the a set of bond future data, determining a set of matching swap data which corresponds to the set of bond future data and displaying an indication of the set of matching swap data in a second display element displayed in the display device; receiving, from a user, a confirmation of the indication of matching swap data; in response to the confirmation, building a data package by a packaging component of the computer system, the packaging component combining the set of bond future data and the set of matching swap data to build the data package therefrom; storing the data package in a storage of the computer system; calculating, prior to separation of the data package, a value for the data package by a calculation component of the computer system and storing the calculated value in a memory of the computer system, and repeatedly calculating and storing updated values until a predetermined time period has expired; and after said predetermined time period has expired, generating and displaying first data and second data by a separation component of the computer system, the first data indicating a bond associated with said bond future data, and the second data indicating a swap associated with said swap data.

Various user interface elements can be provided to allow a user to interact with computing system as described in detail below.

Furthermore, there is provided a tangible non-transitory computer-readable storage medium that stores a data structure holding an order book. The data structure comprises a data package that includes bond future data identifying a bond future, and swap data identifying a swap being matched to the bond future, wherein said data package is a tradable item that keeps the combination of bond future data and matching swap data maintained during trading.

### BRIEF DESCRIPTION OF THE DRAWING

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 is a block diagram illustrating a data processing system according to an embodiment;

FIG. 2 illustrates the process of generating an asset swap future in accordance with an embodiment;

FIG. 3 illustrates the process of processing an asset swap future in accordance with an embodiment;

FIG. 4 is a flow diagram illustrating an embodiment of how to process an asset swap future;

FIGS. 5a and 5b are flow diagrams illustrating valuation methods in accordance with embodiments;

FIG. 6 is a block diagram illustrating a technical implementation in accordance with an embodiment;

FIG. 7 is a flowchart of a method in accordance with an embodiment;

FIG. 8 is a schematic illustration of a computer architecture in accordance with an embodiment; and

FIG. 9 is a schematic illustration of a graphical user interface (GUI) in accordance with an embodiment.

### DETAILED DESCRIPTION

The illustrative embodiments of the present invention will be described with reference to the figure drawings wherein like elements and structures are indicated by like reference numbers.

As will be described in more detail below, an asset swap future (in the following also called: asset swap spread future) concept is provided in various embodiments that improves over conventional techniques in that it enables a future product (or a derivative product of another type) to trade as a packaged forward starting asset swap that delivers into its two separate components. For instance, embodiments exist that allow to offer a futurized product that replicates the yield yield methodology of trading asset swaps. A fitting product offering may then be analogous to the yield yield set-up of OTC asset swaps whilst maintaining the benefits of a standardized, cleared listed derivative. It may 20 have the dates of the cheapest to deliver (CTD) bond (i.e., the cheapest bond that can be delivered to the long position to satisfy the specifications) matched to accurately represent the asset swap spread when traded as a package. Furthermore, unlike in conventional techniques, it may avoid the issue of having to book a new swap every day to keep the swap leg matched to the bond position.

In an embodiment, a yield yield asset swap may be reproduced by being long (short) bond future contract, and paying (receiving) fixed on a par rate swap, e.g. with a notional that is adjusted by the ratio of the CTDs DV01 and the swap DV01, with DV01 (or “Dollar Value of an 01 ”) being also referred to as the dollar duration, base point value, or delta risk. The asset swap spread may be the difference between forward yield of the CTD and the par rate of the forward starting swap. Embodiments may be considered as being analogous to a yield yield OTC asset swap matching the dates of the CTD bond and may be traded as a package. The asset swap future of the embodiments may be a future referencing the spread between the market value of a bond future and an at market forward starting swap with matching dates to the CTD of the respective bond future. The terms of the at market forward starting swap may remain not fixed until expiry of the contract when the swap is booked. Up until that point, the swap may mirror the details of the CTD with the par rate re-adjusted on a daily basis as a reflection of the yield of the CTD and the yield yield asset swap spread.

As apparent from the detailed description, a future contract as provided in various embodiments may be traded and cleared referencing the spread between the market value of a bond future and an at market forward starting swap with matching dates to the CTD of the respective bond future. The contract may be standardized with reference to a specified related bond futures contract and a specified related delivery date allowable under the terms of related futures contract. The terms of the at market forward starting swap may not be fixed until expiry of the contract when the swap is booked. Up until that point, the swap may mirror the details of the CTD with the par rate re-adjusted on a daily basis as a reflection of the yield of the CTD and the yield yield asset swap spread.

Unlike conventional packaging techniques, the asset swap future concept of at least some of the embodiments may be a future product that trades as a packaged forward starting asset swap that delivers into its two separate components. The future may be valued/priced as a theoretical combination of a bond future and a matching swap, and it may therefore trade as a spread throughout the life of the product. However, upon expiry the future may deliver into two separate underlyings: a cleared OTC swap and an eligible bond within the delivery basket of the respective bond future. The party that is long the asset swap future may receive an eligible security within the delivery basket, and may enter into a payer swap against the party that is short the asset swap future. The yield-yield asset swap spread may be tracked, hence the product may aim to follow the CTD bond and re-align the swap daily to match the details of the current CTD bond. Furthermore, with extreme market movements the duration may also be re-aligned in between the prevailing CTD bond and the swap so as to ensure DV01 neutrality. The asset swap future may be quoted and traded in spread 5 terms, i.e., in bps per annum.

There are many advantages involved with the various embodiments. For instance, some embodiments may be well matched to the OTC market as they may be regarded as purely reflecting a yield yield asset swap set up. The underlying swap may also mirror the CTD as it changes throughout the lifetime of the future and may not face the risk of ending up with a stale contract that does not match the CTD. The embodiments may also not face the issue of having different swaps booked on a daily basis as the market moves up until the expiry of the bond future. Some embodiments may adjust for the changes in the par swap rate, durations such as DV01 s as well as dates that match the current CTD. The embodiments may allow trading without having to worry about booking and re-booking of swaps and compression of positions and having to deal with different counterparties and clearing platforms.

There may be physical settlement or cash settlement in various embodiments. That is, in the embodiments, there may be in particular two formats considered, 20 namely a physical or cash settled version whereby the asset swap spread may be determined from the price of the underlying instruments, i.e., bond and swap, or from the actual traded asset swap spread. In reflection of the OTC market, the package may be traded in basis points (bps) and, for fungibility with futures, transformed to a price in clearing systems at the end of every trading day.

Upon physical settlement, after close of trading, the buyer of the asset swap future may receive an eligible security within the delivery basket of the bond future on the delivery day, and may enter into a payer swap with the following specifications: The start date may be the delivery day of the bond future of the respective delivery month; the maturity date may be that of the bond future CTD on the close of trading; the notional may be the number of asset swap spread future contracts traded per account per member, multiplied by the contract value of the respective bond future, multiplied by the hedge ratio which may be DV01 CTD I DV01 Swap; and the fixed rate may be the par rate as calculated on the final settlement day.

Upon cash settlement, after close of trading, the buyer of the asset swap future may receive the following cash amount: invoice amount bond future's CTD bond plus the present value of the floating leg of the swap. After close of the trading, the buyer of the asset swap future may pay the following cash amount: the present value of the fixed leg of the swap. The swap specifications may be the following: The start date may be the delivery day of the bond future of the respective delivery month; the maturity date may be that of the bond future CTD on the close of trading; the notional may be the number of asset swap spread future contracts traded per account per member, multiplied by the contract value of the respective bond future, multiplied by the hedge ratio which may be DV01 CTD/DV01 Swap.

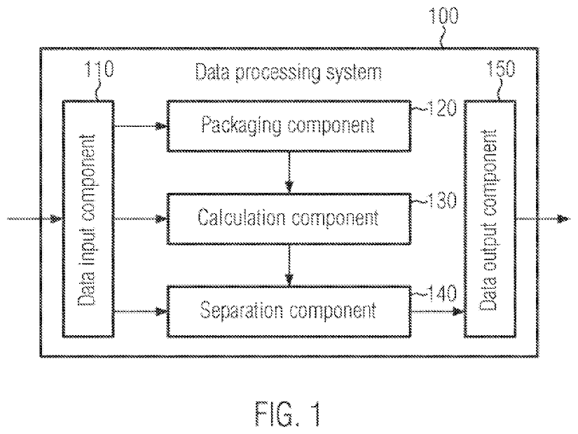

Referring now to the drawings and in particular to FIG. 1, a block diagram is 15 shown illustrating a data processing system 100 according to an embodiment. The data processing system 100 comprises a packaging component 120 which is configured to build a data package by combining bond future data and matching swap data received through data input component 110, and store the built data package in the storage. The data processing system 100 further comprises a calculation component 130 which is configured to calculate a value for the data package and repeat the calculation to calculate updated values until a predetermined time period has expired. Moreover, the data processing system 100 comprises a separation component 140 which is configured to, after said predetermined time period has expired, generate and output data through data output component 150 in accordance with the settlement performed. This data may include first data indicating a bond associated with the bond future data, and second data indicating a swap associated with the swap data. In accordance with the settlement scheme chosen, the first and second data may be used for physical or cash settlement.

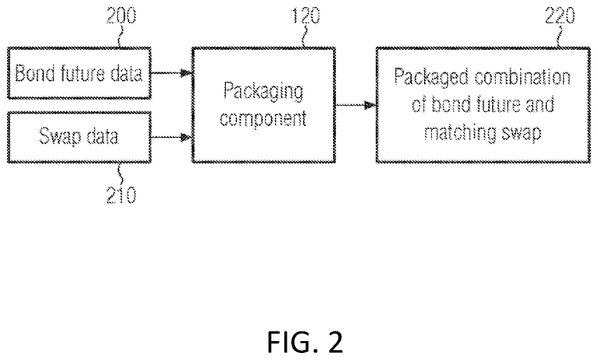

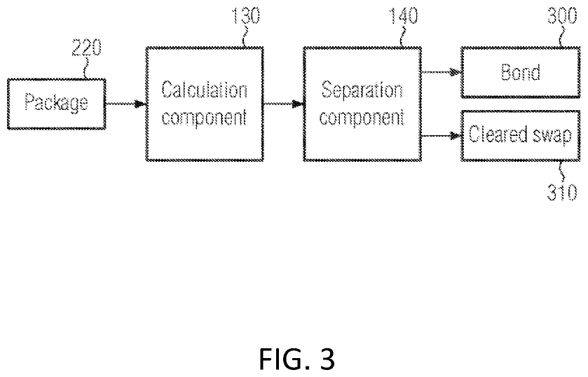

The process performed by the data processing system 100 will now be described n more detail with respect to FIGS. 2 and 3 which illustrate processes of generating and processing an asset swap future in accordance with an embodiment.

In the process of packaging, bond future data 200 and swap data 210 is received by the packaging component 120 through the data input component 110 of the data processing system 100. The packaging component 120 uses the received bond future data 200 and swap data 210 to build a data package 220 therefrom, i.e., a packaged combination of a bond future and a matching swap.

When this data package 220 is being processed, it is received by the calculation component 130 of the data processing system 100. The calculation component 130 then calculates a value (i.e., valuates) for the data package 220 and repeats this calculation to calculate updated values until a predetermined time period has expired, i.e., until the maturity date has been reached.

At this time, the data package 220 is forwarded to the separation component 140 to separate the data package 220 in accordance with the settlement scheme used, for instance by separating the data package 220 into a bond 300 and a cleared swap 310.

As to the pricing and the valuation of an asset swap future according to embodiments, a yield yield asset swap may be reproduced by being long (short) bond future contract, and paying (receiving) fixed on a par rate swap, e.g., with a 20 notional that may be adjusted by the ratio of the CTDs DV01 and the Swap DV01. The asset swap futures spread may be the difference between forward yield of the CTD and the par rate of the forward starting swap.

To value the package, embodiments determined from the futures price the forward yield on the bond future, which would be the yield of the CTD at settlement, and generate the par rate of a forward starting swap with matching dates. The package may be DV01 neutral, and the DV01 s of the CTD as well as the swap may be generated with the ratio being used to adjust the swap notional accordingly.

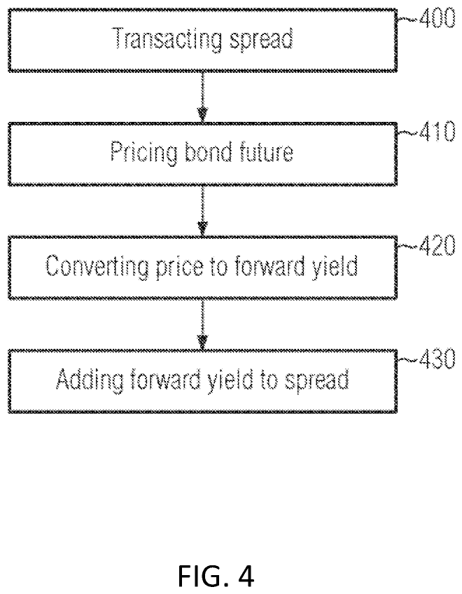

According to FIG. 4, an asset swap future of the embodiments may be processed by transacting the spread in bps in step 400, and then pricing the bond future in step 410. The bond future price is then converted into a forward yield in step 420, and the forward yield is added in step 430 to the transacted spread, which would s equal the swap's fixed rate in an embodiment.

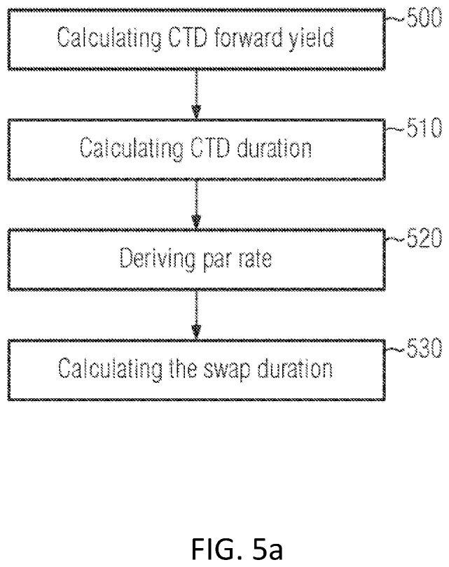

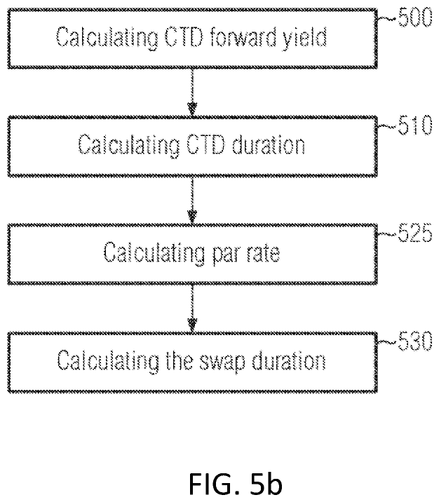

FIG. 5a illustrates a spread valuation method in accordance with an embodiment. In step 500, the forward yield of the CTD is calculated. To calculate the forward yield, the forward price of the CTD bond is required. The forward price of the CTD bond is then equated to the cash flows of the CTD as follows to generate the yield to maturity of the CTD:

$$\frac{FV}{{( 1 + y )}^{n}} + {\sum }_{i = 1}^{n} [ {CF}_{i} . \frac{1}{{( 1 + y )}^{i}} ]$$

where FV is the face value of the CTD, CFi is the cash flow, i.e., coupon of the i^{th} payment from the CTD bond, y is the yield to maturity of the CTD, i is the time until the i^{th} payment will be received, and n is the time to maturity of the CTD.

In step 510, the DV01 of the CTD is calculated. The modified duration of the CTD may be computed as

$$\frac{{\sum }_{i = 1}^{n} \frac{CFi . {( 1 + y )}^{- i}}{V}}{( 1 + y )}$$

where CFi is the cash flow, i.e., coupon of the i^{th} payment from the CTD bond, y is the yield to maturity of the CTD, i is the time until the i^{th} payment will be received, n is the time to maturity of the CTD, and V is the present value of all cash payments from the CTD until maturity.

This may show the effect of 1% change in interest rates on the price of the CTD. Hence the DV01 of the CTD may be equal to the CTD modified duration, multiplied by the CTD forward price/100.

In step 520, the par rate for the forward swap is derived. The implied forward yield may be added on to the traded invoice spread to generate the par rate of the forward swap at that point in time. Finally, in step 530, the swap DV01 is generated.

FIG. 5b illustrates a price valuation method in accordance with an embodiment. In this embodiment, steps 500, 510 and 530 are the same steps or at least similar to the respective steps of FIG. 5a. However, in step 525, the par rate for the forward starting swap is calculated. The start date of the swap may be the delivery date and the expiry date may be the maturity date of the CTD.

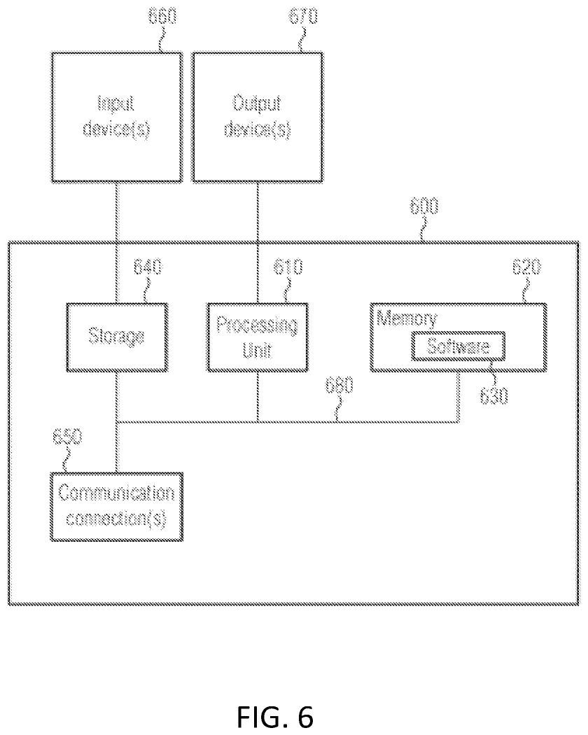

Referring now to FIG. 6, the above embodiments may be implemented using one or more of the computer systems or computer environments as shown in this figure. The computing environment 600 includes at least one processing unit 610 and memory 620. The processing unit 610 executes computer-executable 15 instructions and can be a real or a virtual processor. In a multi-processing system, multiple processing units execute computer-executable instructions to increase processing power. The memory 620 can be volatile memory (e.g., registers, cache, RAM), non-volatile memory (e.g., ROM, EEPROM, flash memory, etc.), or some combination of the two. The memory 620 can store software 630 implementing described techniques, and other data.

A computing environment can have additional features. For example, the computing environment 600 includes storage 640, one or more input devices 660, one or more output devices 670, and one or more communication connections 680. An interconnection mechanism 680, such as a bus, controller, or network interconnects the components of the computing environment 600. Typically, operating system software or firmware (not shown) provides an operating environment for other software executing in the computing environment 600, and coordinates activities of the components of the computing environment 600.

The storage 640 can be removable or non-removable, and includes magnetic disks, magnetic tapes or cassettes, CD-ROMs, CD-RWs, DVDs, or any other medium which can be used to store information and which can be accessed within the computing environment 600. The storage 640 can store instructions for the software 630.

The input device(s) 660 can be a touch input device such as a keyboard, mouse, pen, trackball, touch screen, or game controller, a voice input device, a scanning device, a digital camera, remote control, or another device that provides input to the computing environment 600. The output device(s) 670 can be a display, television, monitor, printer, speaker, or another device that provides output from the computing environment 600.

The communication connection(s) 680 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 600, computer-readable media include memory 620, storage 640, communication media, and combinations of any of the above.

FIG. 6 illustrates computing environment 600, display device 670, and input device 660 as separate devices for ease of identification only. Computing environment 600, display device 670, and input device 660 can be separate devices (e.g., a personal computer connected by wires to a monitor and mouse), can be integrated in a single device (e.g., a mobile device with a touch-display, 30 such as a smartphone or a tablet), or any combination of devices (e.g., a computing device operatively coupled to a touch-screen display device, a plurality of computing devices attached to a single display device and input device, etc.). Computing environment 600 can be a set-top box, personal computer, or one or more servers, for example a farm of networked servers, a clustered server environment, or a cloud network of computing devices.

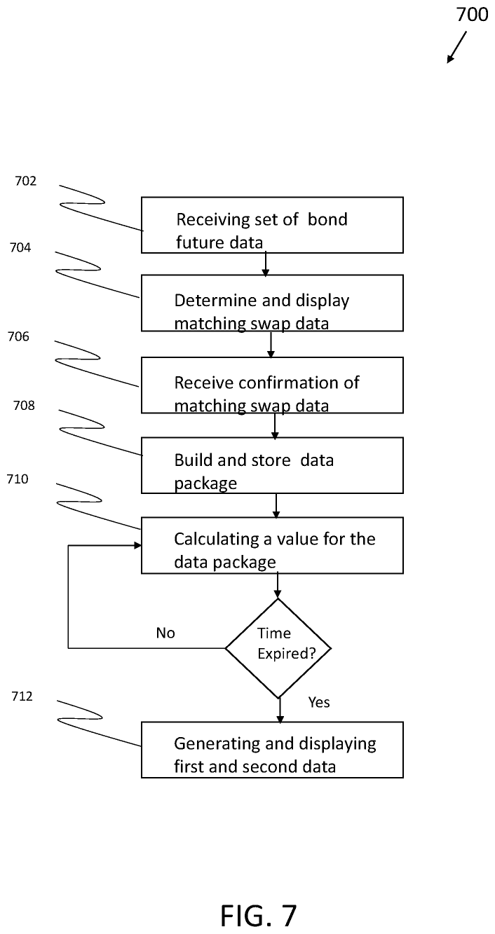

FIG. 7 illustrates a method 700 for creating an asset swap in accordance with a disclosed embodiment. At 702 a set of bond future data is received through an input element of a user interface displayed on a user device. At 704, a set of matching swap data which corresponds to the set of bond future data is determined and displayed on the user interface of the user device. At 706 a confirmation of the indication of matching swap data is received from the user. At 708, a data package is built by a packaging component (such as ASF Manager 802 described below) and stored. The packaging component combines the set of bond future data and the set of matching swap data to build the data package. At 710, prior to separation of the data package, a value for the data package is calculated and stored. This calculating and storing is repeated until a predetermined time period has expired at which time first data and second is generated and displayed to the user at 712. The first data indicate a bond associated with the bond future data, and the second data indicates a swap associated with the swap data.

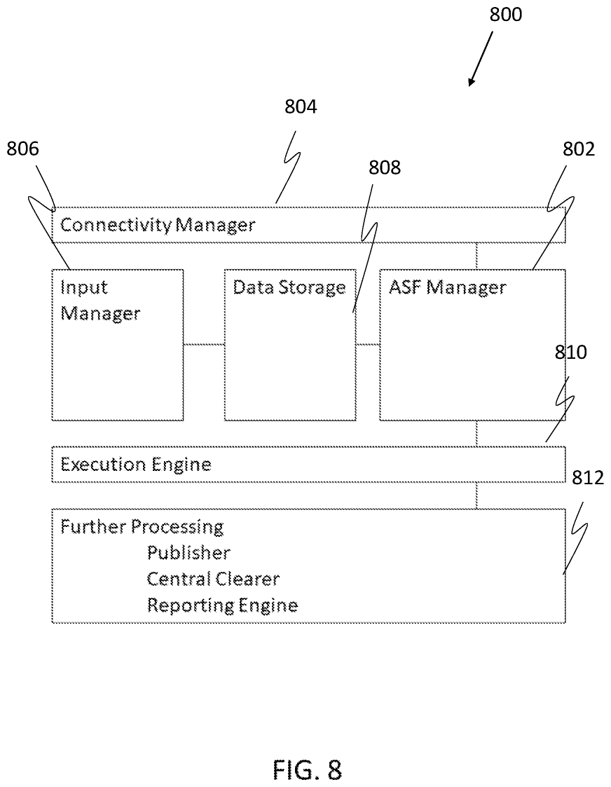

FIG. 8 illustrates a computer architecture 800 that can be used to implement the method of FIG. 7. Architecture 800 can be composed of computing devices, such as the computing device illustrated in FIG. 6. Asset Swap Future Manager (ASF Manager) 802 manages all functionality related to trade preparation, execution, and processing life-cycle events. As an example, ASF 802 can implement the data processing system 100 of FIG. 1. Various types of users can connect to the ASF Manager via Connectivity Manager 804 which generates a graphical user interface (GUI) that can be displayed on a user device for data entry and approval by the user. Users may access the system for trading Asset Swap Futures, for monitoring the market, or for maintaining the proper operations of the overall system. Users may be sorted in different groups with various entitlements, enabling them to perform different functions within the system. Connectivity Manager 804 may offer different connectivity methods. Users may rely on a the GUI or an Application Programming Interface (API). Various combinations of these interfaces can be used.

ASF Manager 802 can also receive various data for its process through Input Manager 806. Input Manager 806 can receive the data from third-party applications or directly from a user through the connectivity manager 804. Data may include reference data, real-time market data, and other necessary data. To give a few examples, data may include all the instrument reference data related to the available future contracts, the related underlying bonds, and related swaps. Real-time market data may include all trades (e.g. timestamp, prices, quantities) of the future contracts, underlying bonds, and swaps. Input Manager 806 can receives the data from various sources, standardizes it for internal purposes, and performs quality assurance.

ASF Manager 802 can also derive additional data points on a regular basis such as the cheapest to deliver bond for each relevant future contract. Input Manager 806 can transmit all the information to the Data Storage 808, from where ASF Manager 802 can access the data. Data Storage 802 can also collect and store all message flow between the components.

ASF Manager 802 details of desired Asset Swap Future trades from users. Users do not have to designate a counterparty to trade with. If no counterparty is defined by the user, then the ASF Manager utilizes Execution Engine 810 that supports a search for liquidity in various market models, such as continuous limit order book, auctions, or request for quote. If users already have a preliminary agreement to trade with another counterparty, ASF Manager 802 allows users of both counterparties to submit trade details to be executed against each other.

When submitting a trade request of an Asset Swap Future, several data points are generally required. Amongst them are (A) the definition of the future contract (i.e., details of the underlying bond and swap), (B) the trade price, (C) the trade quantity, (D) the definition of the floating rate belonging to the swap and (E) the settlement method. Upon receiving trade requests, ASF Manager 802 can perform numerous functions. For example, ASF Manager 802 can validate trade details against applicable regulations for ensuring compliance and validate whether both users are entitled and have agreed to execute this trade. Based on the data provided by the users and enriched with the data available in Data Storage 808, ASF Manager 802 can determine (A) the bond future price, (B) the CTD, and (C) the forward yield relative to the CTD, as well as (D) the characteristics of the swap, such as start date, end date, maturity, notional quantity, and fixed rate (in the manner described in detail above, for example). Once all necessary data is successfully processed, the trade can be executed.

All executed trades can undergo further processing by processing engine 812. For example, the trade data can be forwarded for to the Central Clearer and the Publisher. The Central Clearer provides functions ranging from trade management, risk management, collateral management all the way to delivery management for all counterparties. Counterparties can manage their positions in Asset Swap Futures via the Central Clearer. The ASF Manager enables users to view their trading positions, which are hold within the Central Clearer. The Publisher distributes trades and related information to the wider public.

The lifetime of an Asset Swap Future is definite and has a pre-defined last trading day and a final settlement day. Throughout the lifetime of the contract, ASF Manager 802 provides prices and trades related to Asset Swap Futures to the Central Clearer, for them to perform their functions. Once a contract has finished its last trading day, ASF Manager 802 calculates and determines the final settlement price that is needed for the Central Clearer to perform the subsequent final settlement.

To specify a swap, a user can enter, for example, A) Start Date, (B) Maturity Date, (C) Currency, (D) Notional, (E) Hedge Ratio, (F) Fixed Rate and (G) Floating Rate. The respective cash amounts will be determined by ASF Manager 802 and forwarded to the Central Clearer for processing. A reporting engine can generate various reports, based on data in Data Storage 808, for various users.

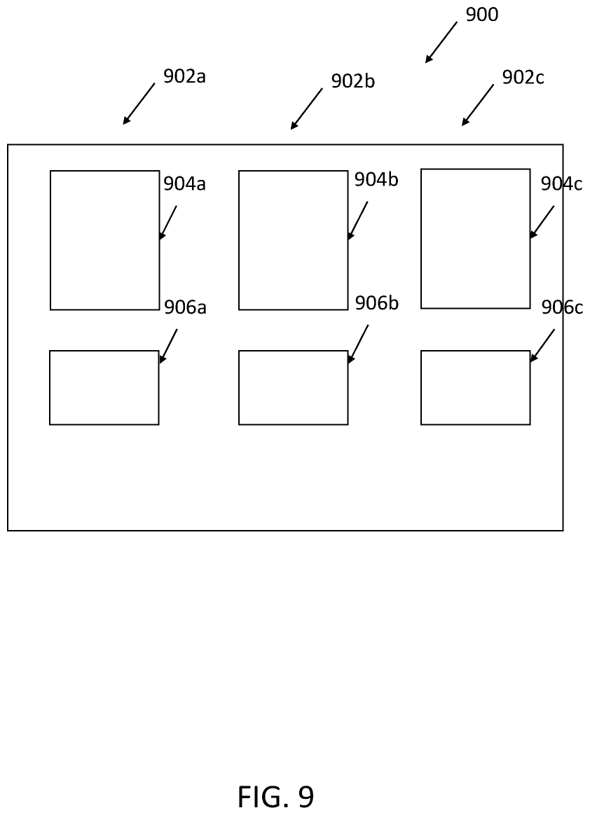

FIG. 9 illustrates graphical user interface (GUI) 900 in accordance with a disclosed embodiment. GUI 900 can be generated by Connectivity Manager 804 (FIG. 8) and displayed, for example, on a user device to allow a user to input data into the system. GUI 900 includes multiple input elements 902a, 902b, and 902c. Each input element input element 901a, 902b, 902c includes a corresponding display field 904a, 904b, 904c and a corresponding selector 906a, 906b, 906c. Manipulation of one of selectors 906a, 906b, 906c by a user causes the bond future data to be displayed in a corresponding display field 904a, 904b, 904c. As an example, display fields 904a, 904b, 904c can be one or more of a number field, a gauge, a graph, a pie chart, or any other indicator of a parameter or value. As an example, selectors fields 906a, 906b, 906c can be one or more of a number dial, a radio selector, a wheel, a slider or any other mechanism for selecting a parameter or value.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed:

1. A computer-implemented method of operating a computer system, the computer system including at least one processing unit, and at least one memory having computer-executable instructions stored therein which, when executed by the at least one processing unit, cause the computing system to accomplish the method comprising:
receiving a set of bond future data through an input element displayed on a user device;
in response to receiving the set of bond future data, determining a set of matching swap data which corresponds to the set of bond future data and displaying an indication of the set of matching swap data in a second display element displayed in the display device;
receiving, from a user, a confirmation of the indication of matching swap data;
in response to the confirmation, building a data package by a packaging component of the computer system, the packaging component combining the set of bond future data and the set of matching swap data to build the data package therefrom;
storing the data package in a storage of the computer system; calculating, prior to separation of the data package, a value for the data package by a calculation component of the computer system and storing the calculated value in a memory of the computer system, and repeatedly calculating and storing updated values until a predetermined time period has expired; and
after said predetermined time period has expired, generating and displaying first data and second data by a separation component of the computer system, the first data indicating a bond associated with said bond future data, and the second data indicating a swap associated with said swap data.

2. The method of claim 1, wherein the bond future data includes start date, maturity date, specified currency, notional value, hedge ratio fixed rate and floating rate.

3. The method of claim 1, wherein the bond future data is selected by the user from respective sets of bond future data displayed in a first display element on a user device.

4. The method of claim 1, wherein the input element includes at least one display field and at least one selector field and wherein manipulation of one of the at least one selector by a user causes the bond future data to be displayed in a corresponding one of the at least one display field.

5. The method of claim 1, wherein the determining comprises determining multiple sets of matching swap data respectively based on different matching algorithms and the confirmation includes a selection of a desired indication of a set of matching swap data.

6. The method of claim 5, wherein at least one of the matching algorithms include matching a start date of the swap with the delivery day of the bond future and matching the expiry date of the swap with the maturity date of the bond.

7. The method of claim 1, wherein the determining a set of matching swap data which corresponds to the set of bond future data is based on a matching algorithm and further comprising:
displaying a parameter selection element on the display device;
receiving from the user a selection of parameters through the parameter section element; and
applying the parameters selected by the user to the matching algorithm.

8. The method of claim 1, wherein the calculating a value for the data package comprises:
determining a bond future price in accordance with said bond future data; and
converting the bond future price into a forward yield, wherein converting the bond future price into a forward yield comprises calculating a bond forward price as
$$\frac{FV}{{( 1 + y )}^{n}} + {\sum }_{i = 1}^{n} [ {CF}_{i} . \frac{1}{{( 1 + y )}^{i}} ] ,$$
wherein y is the yield to maturity of the bond, i is the time until the i^{th} payment will be received, n is the time to maturity of the bond, FV is the bond face value, and CFᵢ is the coupon of the i^{th} payment from the bond.

9. The method of claim 1, wherein the calculating a value for the data package comprises:
calculating a bond duration as
$$\frac{{\sum }_{i = 1}^{n} \frac{CFi . {( 1 + y )}^{- i}}{V}}{( 1 + y )} \cdot \frac{1}{100} ( \frac{FV}{{( 1 + y )}^{n}} + {\sum }_{i = 1}^{n} [ {CF}_{i} . \frac{1}{{( 1 + y )}^{i}} ] ) ,$$
wherein y is the yield to maturity of the bond, i is the time until the i^{th} payment will be received, n is the time to maturity of the bond, FV is the bond face value, V is
the present value of all cash payments from the bond until maturity, and CF; is the coupon of the i^{th} payment from the bond.

10. A computer system, the computer system comprising:
at least one processing unit; and
at least one memory having computer-executable instructions stored therein which, when executed by the at least one processing unit, cause the at least one processing unit to accomplish a method comprising:
receiving a set of bond future data through an input element displayed on a user device;
in response to receiving the set of bond future data, determining a set of matching swap data which corresponds to the set of bond future data and displaying an indication of the set of matching swap data in a second display element displayed in the display device;
receiving, from a user, a confirmation of the indication of matching swap data;
in response to the confirmation, building a data package by a packaging component of the computer system, the packaging component combining the set of bond future data and the set of matching swap data to build the data package therefrom;
storing the data package in a storage of the computer system; calculating, prior to separation of the data package, a value for the data package by a calculation component of the computer system and storing the calculated value in a memory of the computer system, and repeatedly calculating and storing updated values until a predetermined time period has expired; and
after said predetermined time period has expired, generating and displaying first data and second data by a separation component of the computer system, the first data indicating a bond associated with said bond future data, and the second data indicating a swap associated with said swap data.

11. The system of claim 10, wherein the bond future data includes start date, maturity date, specified currency, notional value, hedge ratio fixed rate and floating rate.

12. The system of claim 10, wherein the bond future data is selected by the user from respective sets of bond future data displayed in a first display element on a user device.

13. The system of claim 10, wherein the input element includes at least one display field and at least one selector field and wherein manipulation of one of the at least one selector by a user causes the bond future data to be displayed in a corresponding one of the at least one display field.

14. The system of claim 10, wherein the determining comprises determining multiple sets of matching swap data respectively based on different matching algorithms and the confirmation includes a selection of a desired indication of a set of matching swap data.

15. The system of claim 14, wherein at least one of the matching algorithms include matching a start date of the swap with the delivery day of the bond future and matching the expiry date of the swap with the maturity date of the bond.

16. The system of claim 10, wherein the determining a set of matching swap data which corresponds to the set of bond future data is based on a matching algorithm and the method further comprising:
displaying a parameter selection element on the display device;
receiving from the user a selection of parameters through the parameter section element; and
applying the parameters selected by the user to the matching algorithm.

19. The system of claim 10, wherein the calculating a value for the data package comprises:
determining a bond future price in accordance with said bond future data; and
converting the bond future price into a forward yield, wherein converting the bond future price into a forward yield comprises calculating a bond forward price as
$$\frac{FV}{{( 1 + y )}^{n}} + {\sum }_{i = 1}^{n} [ {CF}_{i} . \frac{1}{{( 1 + y )}^{i}} ] ,$$
wherein y is the yield to maturity of the bond, i is the time until the i^{th} payment will be received, n is the time to maturity of the bond, FV is the bond face value, and CFᵢ is the coupon of the i^{th} payment from the bond.

18. The method of claim 10, wherein the calculating a value for the data package comprises:
calculating a bond duration as
$$\frac{{\sum }_{i = 1}^{n} \frac{CFi . {( 1 + y )}^{- i}}{V}}{( 1 + y )} \cdot \frac{1}{100} ( \frac{FV}{{( 1 + y )}^{n}} + {\sum }_{i = 1}^{n} [ {CF}_{i} . \frac{1}{{( 1 + y )}^{i}} ] ) ,$$
wherein y is the yield to maturity of the bond, i is the time until the i^{th} payment will be received, n is the time to maturity of the bond, FV is the bond face value, V is the present value of all cash payments from the bond until maturity, and CFᵢ is the coupon of the i^{th} payment from the bond.
